(19) United States
(12) Patent Application Publication
(10) Pub. No.: US 2023/0359659 A1
(43) Pub. Date: Nov. 9, 2023

(54) SYSTEMS AND METHODS FOR ADVANCED TEXT TEMPLATE DISCOVERY FOR AUTOMATION

(71) Applicant: NICE LTD, Ra'anana (IL)

(72) Inventors: Oz GRANIT, Ramat-Gan (IL); Yuval SHACHAF, Even Yehuda (IL); Eran ROSEBERG, Hogla (IL)

(73) Assignee: NICE LTD, Ra'anana (IL)

(21) Appl. No.: 17/737,495

(22) Filed: May 5, 2022

(51) Int. Cl. G06F 16/35

(52) U.S. Cl. CPC G06F 16/355

(57) ABSTRACT

A system and method may identify computer-based processes involving the use of text templates which may be candidates for automation. Using one or more computers, embodiments of the invention may sort low-level user action information for a given process which may be received as input; search for a plurality of strings pasted multiple times in the sorted information; discard one or more of the strings found from the search which correspond to a set of criteria (e.g., found to be shorter, or pasted, or edited fewer times than a predetermined threshold); group the strings according to an identifier of the target app where each string was pasted; iteratively calculate a similarity score for strings or groups of strings, and cluster strings or groups for which the similarity score is below a predetermined threshold, to form final clusters; and suggest the final clusters as automation opportunities to, e.g., a business analyst.

### FIELD OF THE INVENTION

The present invention relates generally to automation of computer processes previously performed by users; in particular to identifying automation opportunities that relate to copied-and-pasted strings used as text templates.

### BACKGROUND OF THE INVENTION

Companies and organizations such as call centers, or other businesses, may identify (e.g. “discover”) business processes or “flows” that are significant candidates for robotic process automation (RPA), in that they are both feasible for automation and that automation would have high potential return on investment (ROI) by saving significant manual efforts and workload when being handled by automated computer processes, “bots”, or robots instead of human agents. Such automation opportunities may involve human-computer interactions. A bot created to replace or automate human-computer interactions may be an autonomous program that may interact with computer systems, programs, or users, and which may operate as would a human user.

In some approaches used in the art, this discovery and analysis process is sometimes done manually, by a person, which may be subjectively-biased, time consuming and very expensive. Thus, various methods exist, machine based, human based, and machine-human hybrids, to find automation opportunities. Technologies such as process mining tools may use high-level system-specific event logs as input data, such as case identification (ID) (e.g. Process ID), activity ID and, timestamp to identify automation opportunities. Log data is, by definition, labeled (labels exists in the data gathered from the event logs) making it much simpler to analyze automatically. A case ID may identify the process instance and an activity ID may specify the task that has been performed as part of the process. It should be noted, however, that such data is typically provided by the application itself and may not be provided for all applications. In addition, data such as an activity ID, user selection and input may be data internal to a program and may not be provided to other programs. Thus, some of the shortcomings of many process-mining procedures may be rooted in the lack of complete data/information on, e.g., multi-program processes; and the crucial part that a process must be chosen manually as a potential candidate for process automation in advance.

Some recent approaches may allow recording low-level event data that may not be associated with a specific process (e.g. case ID) or activity, but rather with a desktop window which has a name and with a program or application operating the window (e.g. an Internet browser)—and then identify routines and processes based on, e.g., unsupervised-learning-based analysis of recorded data. Such broad data gathering process may mitigate the two shortcomings noted above. However, approaches based on using noisy and untagged user desktop actions as input data pose a great challenge in the context of grouping discovered routines into meaningful maps describing processes that may be chosen as candidates for automation. To this end, unsupervised learning automation discovery procedures may employ a probabilistic approach or framework to analyze the input data and identify automation opportunities of high ROI. However, a particular such approach often fails to satisfy an ideal cost-to-performance ratio—thus either requiring an additional, manual automation discovery procedure for identifying additional automation opportunities, or being formidably computationally costly.

When it comes to automation discovery of text templates, which constitute significant automation opportunities (often having large ROI), a low-level-user-action-based approach may be more beneficial than process-mining alternatives in that the former may recognize the use of text templates in a variety of user actions, e.g., in contexts where explicit information regarding copying and pasting (e.g. using ctrl-C and ctrl-V) a given string or piece of text is not provided by a particular app, or in cases where such copying and pasting actions are performed across multiple apps and may therefore be difficult to trace. Such an approach, however, requires appropriate (e.g., natural language processing (NLP) based) algorithmic solutions in order to handle vast amounts of noisy user action data in order to correctly and beneficially identify desirable automation opportunities and avoid flagging a plurality of “false-positive” cases as opportunities that may then be discarded by, e.g., a business analyst.

### SUMMARY OF THE INVENTION

A system and method may identify computer-based processes involving the use of text templates which may be candidates for automation. Using one or more computers and/or computer processors, embodiments of the invention may sort low-level user action information for a given process which may be received as input (e.g., as a dataset of computer actions); search for a plurality of strings pasted multiple times (e.g., from a first app to another, different second app) in the sorted information; discard or remove one or more of the strings found from the search which correspond to a set of criteria (e.g., found to be shorter, or pasted, or edited fewer times than a predetermined threshold); group the strings according to an identifier of the target app or application where each string was pasted; iteratively calculate a similarity score for strings or groups of strings, and cluster strings or groups for which the similarity score is below a predetermined threshold, to form final clusters; and suggest the final clusters as automation opportunities to, e.g., a business analyst.

In some embodiments, the clustering of strings or of groups of strings may involve a hierarchical agglomerative clustering algorithm (which may include, for example, measuring at a geometric distance and/or measuring a difference between sets according to an appropriate representation of strings which may be achieved for example using word embedding methods as known in the art).

In some embodiments, searched strings may be found in routines of different types (e.g., copy-paste, input text, and the like). Embodiments may collect, for a given string, one or more actions following or preceding a pasting of the string from the sorted low-level user action information and include one or more of the actions in the suggested automation opportunities.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device which may be used with embodiments of the invention.

FIG. 2 is a flowchart showing an initial template candidate finding procedure which may be used as part of a text template discovery algorithm according to some embodiments of the invention.

FIG. 3 is a flowchart illustrating a potential text template bank filtering procedure which may be used as part of a text template discovery algorithm according to some embodiments of the invention.

FIG. 4 is a flowchart showing a potential text template instance-based screening procedure which may be used as part of a text template discovery algorithm according to some embodiments of the invention.

FIG. 5 is a simplified illustration of an agglomerative hierarchical clustering of text template candidates according to some embodiments of the invention.

FIG. 6 is a flowchart depicting a simple text template discovery procedure according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention may apply novel clustering and machine-learning approaches to greatly improve discovering the most significant business flows for automation of text-template-related routines and processes expected to have a significant return of investment (ROI). Embodiments of the invention may identify text-templates in the stream of actions, which are often missed by the routine and/or process mining algorithms. Embodiments may involve or include multiple classification and/or clustering algorithms and/or procedures consisting of, for example, starting with finding and/or collecting text template routine and/or process instances by searching for underlying actions (such as copying text from a first app and pasting text in a second app) within a time window and a predefined number of intermediate actions, and employing robust text-template edit rules (such as quantifying the changes to the duplicated string after pasting) to identify an agent template edit task; then segmenting collected instances into groups by target application in which the string was pasted; then finally clustering slightly different text template instances using natural language processing (NLP) techniques as further demonstrated herein.

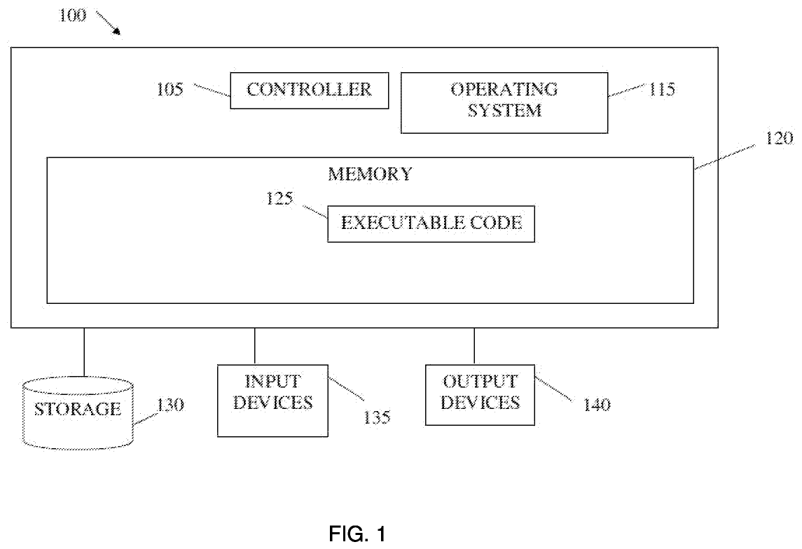

FIG. 1 shows a high-level block diagram of an exemplary computing device which may be used with embodiments of the invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of the procedures and/or calculations discussed herein, and the modules and units discussed, may be or include, or may be executed by, a computing device such as included in FIG. 1, although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data such as low level action data, output data, etc.

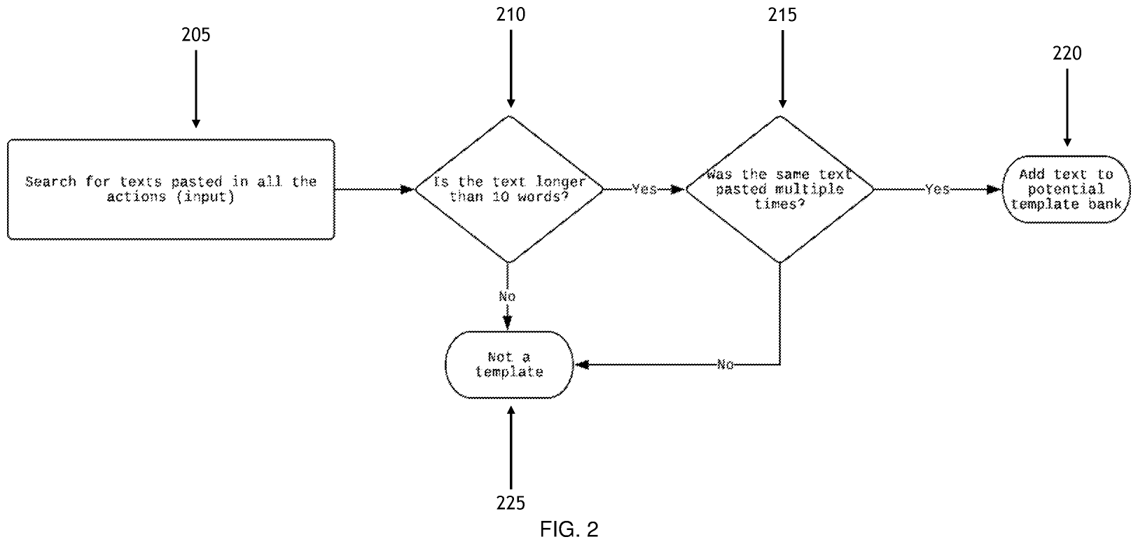

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIGS. 2-6 according to embodiments of the invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as user action data or output data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention may generally be applied to analyzed data (e.g. low-level user action information items) describing actions of human-computer interaction, such as user input events or actions to a graphical user interface (GUI) and used in, e.g., an automation discovery procedure. An example such procedure (to be denoted AD herein) used as part of the Automation Finder system by NICE, Ltd. will be used as a non-limiting example throughout, although those skilled in the art will recognize that the invention may as well be applies to different procedures and approaches as well.

Low-level user action as used herein (e.g., as used in automation frameworks and procedures such as AD) may refer both to the action itself, typically input by a user received by a computer, and the data that describes such an action, and in addition a generalized description or name for the action which applies to multiple specific instances of the same action or similar ones (in terms of their functionality). While the present disclosure will be focused on such low-level user action, it should be noted that embodiments of the invention may also be applied to different kinds of actions or tagged/untagged data describing user actions which may be, e.g., sorted by execution time.

A low-level user action or low-level user action item may be for example a mouse or other pointing device click, a keyboard input to a text field, a cut command, a paste command, a certain keystroke or set of keystrokes (e.g. ctrl-P, alt-F1, etc.). Data describing such user actions (e.g. a low-level user action item) may include for example the type or description of action item or an input item description (click, cut, paste, text entry, etc.); action component details (e.g. the title of window item to which input is applied, e.g. the name of the text field having text entered; the title of the button or control being clicked on, etc.); a user name or ID (e.g. the name of ID of the person providing the input or logged in to the computer or terminal); a time or timestamp of the action; screen window information such as the title of the screen window into which data is entered or on which the relevant data is displayed, and the name of the program or application executing with which the user is interacting (e.g. the program displaying the window such as the Internet Explorer browser).

A window may be for example a defined sub-area of the screen which may typically be resized and moved by a user, in which data is displayed and entered for a particular task or software program. For the point of view of the computer by which a window is displayed, a window may be a graphical control element including a visual area with a graphical user interface (GUI) for the program it belongs to, typically rectangular. A window typically has a name displayed, typically at its top—for example, a window allowing a user to edit a text document may have a name or title including the filename of the document and the program being used to edit the document. A window may be related to two different software programs: the name of the program or application executing the window, such as a browser such as Internet Explorer; and a remote or local program which controls or owns the substance of the window.

The local or remote program executing the substance of the window may not provide adequate or any data, and thus embodiments may capture low level action data (e.g. from the OS servicing the program and not the program) instead. In many cases, the name or title for a window may be accessible from the OS of the computer executing the program owning or displaying the window, while the program owning or displaying the window may not allow or provide access regarding its own name, function etc. via system-specific event logs.

A system collecting low-level user action data and/or information, e.g., as part of the AD framework, may be illustrated in the context of a contact center, although embodiments of the invention may be used in other contexts. In such center, a number of human users such as call-center agents may use agent terminals which may be for example personal computers or terminals. Terminals may include one or more software programs to operate and display a computer desktop system (e.g. displayed as user interfaces such as a GUI). In some embodiments, software programs may display windows, e.g. via desktop system, accept user input (e.g. via the desktop system) and may interface with server software, e.g. receiving input from and sending output to software programs. Client data collection software, e.g. the NICE RT™ Client software, an Activity Recorder or Action Recorder, may execute on or by the terminals and may monitor input to different programs running on them, e.g. taking input from an OS or other system. For example client data collection software may receive, gather or collect a user's desktop activity or actions, e.g. low-level user action information or descriptions, and send or transmit them to a remote server, e.g. a NICE RT™ Server.

The client data collection software may access or receive information describing user input or actions via for example an API (application programming interface) interface with the operating system and/or specific applications (e.g. the Chrome browser) for the computer or terminal on which it executes. The remote server may collect or receive data such as user action information or descriptions, combine actions into a file, and export them as for example JSON (JavaScript Object Notation) files via for example an HTTPS (Hypertext Transfer Protocol Secure) connection to an automation finder server, which may receive and store action data and other data in a database, which may be then be processed. In some embodiments the remote server and automation finder server may be contained in or executed on the same computing device, unit or server. One or more computer networks (e.g. the internet, intranets, etc.) may connect and allow for communication among the components of an automation discovery or finding system (such as the remote and automation finder servers, the agent terminals, and so forth). Agent terminals may be or include computing or telecommunications devices such as personal computers or other desktop computers, conventional telephones, cellular telephones, portable or tablet computers, smart or dumb terminals, etc. Terminals and servers discussed herein may include some or all of the components such as a processor shown in FIG. 1.

In some embodiments, the client data collection software may operate with permission of, e.g., an organization's operating terminals, and may collect for example user input event data, and may be tuned or configured to not collect certain data. For example a user may configure the data collection software to operate on or collect data from only certain windows and applications (e.g. windows with certain titles, or certain URLs (uniform resource locators) or website addresses), and may ignore for example windows accessing certain URLs or website addresses. The client data collection software may collect data from Internet based windows and/or non-Internet based windows.

In some embodiments, low-level user action data collected may be in the form of Windows Handles and their properties as provided by Windows API (e.g. Win-32). The event logs files describing these data collected desktop events may be exported in a JSON format, using appropriate files, and transferred to a server. The data may include for example event or action time (e.g. start time, but end time may also be included); user details (e.g. name or ID of the person providing the action input or taking the action in conjunction with the computer); action details or description (e.g. mouse-click, text-input, keyboard command, etc.); the details of the window in which the action takes place, such as the window size, window name, etc.; the name of the program executing the window; and text if any that was input or submitted (in text actions). Other or different information may be collected. User details or ID may help to tie together actions to related processes and infer process orderings.

Each low-level user action may be described in a database by several fields of the action data such as action time, user details, action details, window name and size, program executing the window, and whether or not text was entered. A generalized name or description may also be created and associated with the action, where the generalized name has certain specific information such as user ID, timestamp, and other tokens in the data (e.g., names, dates, etc.) removed or replaced with generalized information. Multiple specific instances of similar actions may share the same generalized name or description. Thus actions may be stored and identified by both identifying the specific unique (within the system) instance of the action, and also a generalized name or description.

Table 1 below illustrates example action data for an example scenario in which an agent logs in into an ordering system application; as with other data used in examples other specific data and data formats may be used. The agent may open or start the ordering system, enter her or his username and password in a login screen, and then continue working on a case e.g., move to the new orders screen. This includes several low-level user actions as described in Table 1. First, the agent, identified as Agent1 in the User column, at time 10:00:00, clicks twice using a mouse left-click on the MyOrderingSystem icon on the desktop display (window Desktop indicates the desktop on a Windows style system, where windows may be displayed on the desktop). The login screen or window may open or pop up (named per collected data MyOrderingSystem-Login), and the agent may enter his username (e.g. “Agent1”) and password (e.g. “myPassword”) into the fields identified in the Action column, and successfully logs in. The text collected as data may be the entered agent name and password. The agent may then click on mouse left-click on the NewOrders view inside the MyOrderingSystem to display new orders.

TABLE 1

| | | | Action Description or | Text |
|---|---|---|---|---|
| User ID | Time | Window Name | Type | Entered |
| Agentl | 10:00:00 | Desktop | Left-Dbl-Clickon | |
| | | | MyOrderingSystem | |
| Agentl | 10:00:10 | MyOrderingSystem-Login | lnputText on Username | Agentl |
| Agentl | 10:00:20 | MyOrderingSystem-Login | lnputText on Password | myPassword |
| Agentl | 10:00:30 | MyOrderingSystem- | Left-Click on NewOrders | |
| | | MainView | | |

Data such as presented in Table 1 may generally be gathered or received from multiple physically distinct user terminals operated by multiple different users, and is analyzed at a central location or server not at any of the user terminals (typically be a processor separate from terminal processors); however, data analysis may be performed at a user terminal which also collects user data. At for example a central server data received from the terminals describing the low-level user action information or items may be used to determine subprocesses, or routines, which may be for example a series of actions that repeat across the data, and possibly repeat across data divided into contexts. An item of information describing or defining a low-level user action may include for example an input type description (e.g. the type of action the user performed as input: mouse click, left click, right click, cut, paste, typing text, etc.), a user name, and screen window information such as title or name. (e.g., as computer processes in this context may be displayed as windows, each window may have a title or name which may describe the user-facing application to which the user provides input.) Actions may be stored and identified both identifying the specific unique (within the system) instance of the action, and also a generalized name or description that identifies the action in a way such that actions of similar functionality will have the same generalized name. Both the specific and generalized identification or name may be linked or stored together in the system. Sequential pattern mining may be applied to determine routines, each routine including a series of low-level user actions which are reoccurring in the data.

Routines may be grouped or clustered by, for example, representing each routine as a vector and clustering or grouping the vectors (e.g. by calculating a distance between routine vectors and then using an algorithm such as the known Louvain method algorithm). Each user action may be associated with or represented by a user action vector, and by extension each routine may be associated with a routine vector which may be calculated or generated from user action vectors associated with low-level user actions in the routine. The routine vectors may be grouped or clustered to create processes, which may be considered a task such as a business task that may be large enough and otherwise suitable for automation. Particular actions or a set of actions in the low-level user action data used for finding or discovering a given routine and/or process may otherwise be known as “instances” of the routine and/or process. For each process, an automation score may be calculated, for example based on the process instances in the low-level user action data (e.g., the same data on top of which the routines and process were abstracted). Based on this score, a user may create an automation process such as a bot which may automatically—e.g. via computer function—complete the process which previously was performed by a person interacting with a computer. In some embodiments of the invention, the corresponding bot may be created (e.g. by a processor shown in FIG. 1) automatically and, for example, execute (e.g. by another processor shown in FIG. 1) the automated process under consideration at a predetermined point in time (e.g., at a particular timestamp). Grouping identified or determined routines into business processes and calculating an automation score for a given process is known in the art. Text template related actions as used herein may thus refer to low-level user actions such as the examples found in Table 1; those skilled in the art may recognize, however, that other embodiments of the invention may be applied to different input data which may not be limited to, e.g., low-level user action information.

Text templates as used herein may generally refer to patterns involving copying and pasting blocks of text. An illustrative example of a text-template may involve 2 or 3 different applications. The user will export, and/or copy, and/or duplicate a particular or constant string or text from a saved location (which is usually the first action discovered by our invention) which may be, for example:
First Name:
Last Name:
Passport Number:
Flight Number:
Email Address:
Arrival Date:
Thanks,
Customer Service Team
   into a new app, such as a new email message or a new form. In the present non-limiting example (to be used throughout the present document), a user—which may be an agent working at a call center of an airline—may use the above template in different contexts and as part of different computer applications, for example as part of composing an email message to a customer mailing list (e.g., using an organization-supported email application such as Microsoft Outlook), or in the context of writing formal documents concerning a particular customer for vendors and/or associates (e.g., using a text editor or word processing software such as Microsoft Word). The constant or replicated text may have empty details to fill-in, for example data relevant to a specific customer, client, or scenario. In such case, the agent may copy the text template and then manually fill out the required fields according to a given customer or passenger details. Other text templates in various formats may, however, be used in different embodiments of the invention.

In many cases, different users or agents may use slightly different versions of a single template, i.e., approximately identical or highly-similar strings which differ by minor entries such as different signature/greetings or very small changes to the core text. Such text-template routines and/or processes may not be identified using prior art machine learning (ML) techniques as known in the art—as the slight differences in agent or user actions might not allow categorizing them as particular instances of a general text-template routine or process. Existing techniques might therefore not identify desirable text template automation opportunities or incorrectly suggest undesirable such opportunities based on noisy user-action data, resulting in reduced ROI on process automation. Embodiments of the invention may allow overcoming such issues and correctly identify such different versions as a single template in order to show or classify them as a singular and unique automation opportunity—e.g., using the natural language processing (NLP) and ML techniques used as part of the template clustering procedure described herein. In this context, some embodiments of the invention may use or employ an agglomerative-hierarchical clustering algorithm, in which the Jaccard similarity formula is used as a distance metric as further explained herein. Those skilled in the art would recognize, however, that alternative algorithms such as different types of word-embedding and/or weighted/unweighted term frequency-inverse document frequency (TF-IDF) algorithms—as well as alternative distance metrics such as, e.g., Levenshtein distance—may be used in different embodiments.

In order to detect text-templates, e.g., beyond routine- or process-mining algorithms, embodiments of the invention may involve or include multiple classification and/or clustering algorithms and/or procedures consisting of multiple stages. A non-limiting such example procedure is described herein.

The algorithm or procedure may start by sorting, classifying or organizing all actions and/or information associated with user actions (for example “Action Description or Type” and additional identifier fields found in Table 1) which may be stored in, e.g., a low-level user action database—by or according to the user or agent performing or executing the action (e.g., using a user or agent ID), and/or by action time (e.g., the clock time and/or timestamp recorded for a given action), resulting in a data-frame of chronological actions per agent or user. In some embodiments, low level user action information and/or data may first be sorted according to particular users (for example using a user ID)—and, for each user, information or data may then be sorted according to the action time (which may be for example a universal time-stamp); those skilled in the art would recognize, however, that many alternative sorting schemes and/or approaches may be used in different embodiments of the invention. Once an appropriate low level user action information is sorted, an appropriate text template discovery procedure executed by, e.g., computer device or system 100 may be applied to the sorted data-frame.

FIG. 2 is a flowchart showing an initial template candidate finding procedure which may be used as part of a text template discovery algorithm according to some embodiments of the invention. In step 205, embodiments of the invention may look or search for some or all texts or strings pasted in the sorted low-level user action data and/or information and/or descriptions included in a corresponding dataset or data-frame for a given agent or user. In some embodiments, this may be achieved by first searching for “copy to clipboard” (e.g., Ctrl+C is pressed by the user under consideration) actions in the low level user action data and/or information and for subsequent pasting actions (e.g., Ctrl+V) in for example a different application window; once found, such action pairs or sequences may be marked as a “paste action” in for example a modifiable data structure such as Table 1. Alternative classifications and marking of low level user actions (such as for example using different keyboard shortcuts for copying/yanking and/or pasting) may be used in different embodiments of the invention. Texts themselves may be searched for example under a corresponding field in the low level user action database under consideration (e.g., under the “Text Entered” field in Table 1) such that the amount of paste actions per piece of text may be counted. Embodiments may then check, for a plurality of the strings found in the search, if each given string or text is shorter than a modifiable, predetermined or predefined threshold (e.g., 10 word length; step 210). In case a given string is found shorter than the threshold, it may simply be discarded or removed (step 225). If, however, the string is longer than the threshold, embodiments may check the action data to find whether the same text has been pasted multiple times—e.g., more or fewer times than another predetermined threshold (for example more than 5 times) within a given time window (for example within 2 hours; step 215. In principle, however, the time window may be infinite and encompass the entire user action data frame); in case the aforementioned criteria are satisfied—the text and corresponding routine and/or process, which may be a set of low-level user actions including the text under consideration, may be saved or added to a dedicated bank (e.g., a memory buffer in memory 120; step 220) of potential text templates or template candidates, which may be further utilized at subsequent stages of the text template discovery used in different embodiments of the invention. Otherwise, embodiments may discard or remove the text and corresponding actions and thus avoid considering it as a text template candidate (step 225).

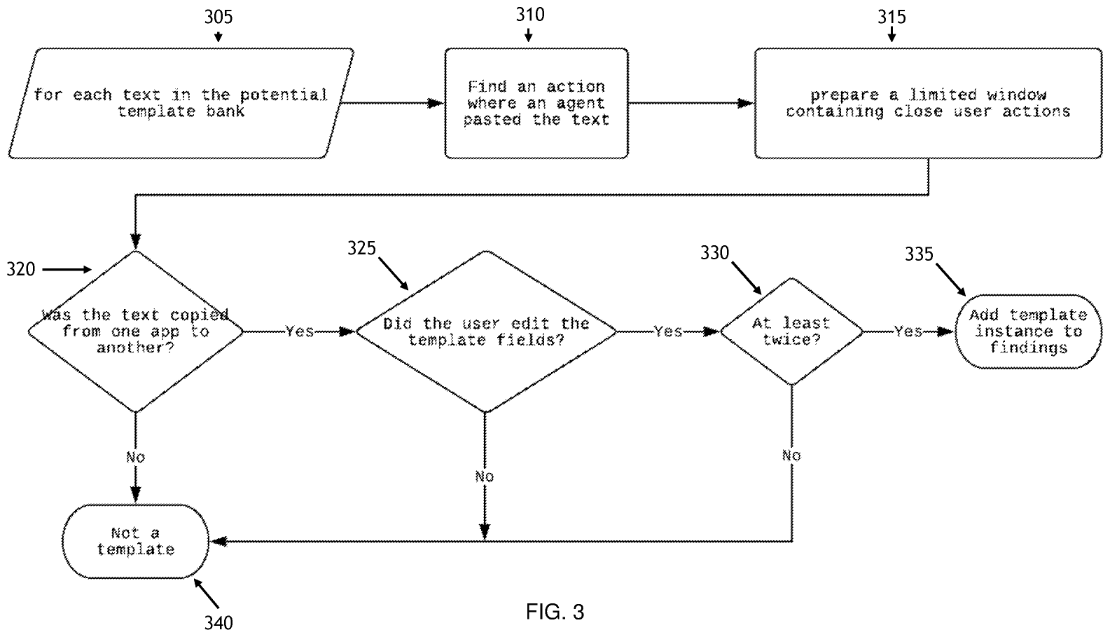

FIG. 3 is a flowchart illustrating a potential text template bank filtering procedure which may be used as part of a text template discovery algorithm according to some embodiments of the invention. Given an input bank or repository of potential routines or processes suspected or classified as text templates (e.g., gathered or established using a template candidate finding procedure as illustrated herein; step 305), embodiments of the invention may filter or screen strings found to be inappropriate based on a plurality of criteria (e.g., including, but not limited to, those described herein). Embodiments may for example search over each given routine or process to find and collect an action where an agent pasted the text (step 310). That is, a database of low-level user actions may be searched to find pasting actions where a particular string or piece of text was inserted or pasted. Embodiments may then prepare or collect a window of actions including a series of actions over time, e.g. occurring within a time window, or a window of a number of actions associated with, preceding and/or subsequent to the pasting action found (which may amount to, for instance, 4 preceding and 4 subsequent actions; step 315). In some embodiments of the invention, some or all of the collected actions may be included in or incorporated into the automation opportunities provided as output—e.g., following a text template clustering procedure as further described herein. Collected actions may thus include a set or list of sequences, where each sequence includes a list of one or more action identifiers—in accordance with the corresponding discussion regarding low-level user actions and information as described herein. Identifiers which may be included in the collected actions may correspond or describe, for instance, a given string, a copying of the string, and a pasting of the string. It may then be checked whether the pasted text or string was copied from an app different than the one to which the text was pasted, or whether it was pasted from a first app to another, different second app (this may be achieved, e.g., by checking and/or comparing app identifiers for the two apps; step 320). If so, embodiments may check whether the executing user or agent edited the template fields (step 325), and whether the corresponding strings edited more than a predefined number of times within a time window, or a window of a number of actions as referred to herein, by a user after pasting (e.g., whether a number of edits larger than a predetermined threshold—for example more than twice within an hour—were performed; step 330). In a positive case—the corresponding routines and/or processes will be added to a pool or bank of template findings (step 335), which may be further utilized in subsequent stages of a text template identification algorithm or procedure as disclosed herein. However, in case the answer to any of steps 320-330 is found to be negative, then the text and corresponding actions and/or routines and/or procedures may be discarded and removed from the bank or pool of potential text template candidates (step 340).

Finding and/or filtering of potential template candidates as outlined in FIGS. 2-3 may, for example, be achieved using a caller function to go over the sets of actions flagged or found as template candidates and collected in the bank as explained herein, and to return a data-frame being a window of user actions found around the corresponding pasting actions (e.g., 4 preceding and 4 subsequent actions) together with their action IDs and/or corresponding data or metadata. As noted herein in the context of a potential text template bank filtering procedure, embodiments may recognize different action or routine types as copying and pasting actions by the user or agent: input text actions, for example, may be recognized as a pasting action in case the string inserted was copied in a corresponding, preceding action. Embodiments may thus recognize a given string which may be included in a plurality of routines of different types (e.g., copy-paste and input text) as a single business process or procedure, and therefore as a single corresponding automation opportunity. Various additional action types may be recognized as copy-paste actions in different embodiments of the invention—e.g., according to an organization's or a business analyst's preferences.

A template-detection-worker function may then receive the action data frame prepared by the caller function and return a list of sequences, which may be a list of action IDs including the copying and pasting actions by the user or agent, together with template candidate texts or strings. In some embodiments, the caller or worker functions may calculate the difference, or delta (e.g., in seconds) between copy and paste actions as part of filtering candidate template candidates. In such a manner, candidates in which the difference exceeds a predetermined threshold (e.g., 100 seconds) may be discarded as non-templates, while those where the difference is below the threshold may be kept in the template candidate bank. Similarly, the caller or worker functions may count the number or appearances of a plurality of routines associated with a given template candidate in the low-level action data or dataset, and discard or remove candidates for which corresponding routines do not exceed a predetermined number of appearances in the low-level action data (e.g., a threshold of at least two appearances). Candidates for which strings were not copied from one app and/or window to another, different app and/or window, or where a number of pasting actions to the same target app or application and/or window does not exceed a predetermined threshold (e.g., pasting has to occur twice) may be discarded as well. Additional or alternative conditions and/or constraints for finding, keeping or discarding text template candidates may be employed or included, e.g., in caller and/or worker functions as part of other embodiments of the invention. Caller or worker functions may be applied to template candidate instances in an iterative manner, e.g., calculate the time difference between copying and pasting actions for a first instance of a given routine for a given template candidate, then performing the same calculation for a second instance, a third instance, and so forth—and then move on to the next template candidate and calculate time differences in instances of a routine for that candidate, etc.

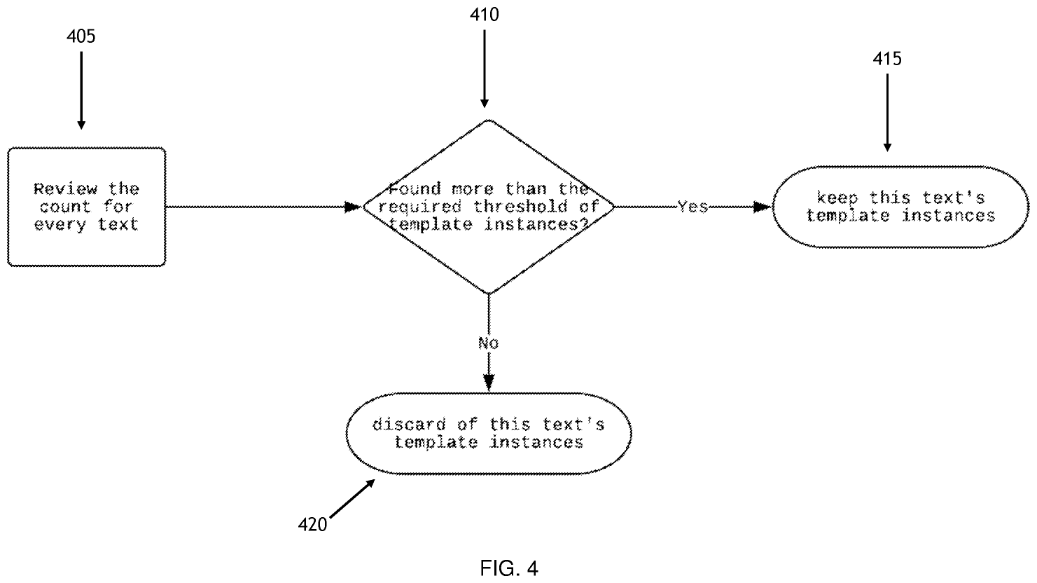

FIG. 4 is a flowchart showing a potential text template instance-based screening procedure which may be used as part of a text template discovery algorithm according to some embodiments of the invention. In step 405, the number of instances for a given routine or a plurality of routines and/or processes containing the same copied and/or pasted text or string may be counted. It may then be checked if the counted number of instances exceeds a predefined threshold (step 410), and in the positive case, the corresponding routine and/or process instances may be kept and/or stored in, e.g., the text template candidate bank (step 415). Otherwise, such instances may be discarded or removed (step 420). Embodiments of the invention may thus keep or discard text template candidates based on the number of occurrences counted for all template related routines for a given string or text, and/or based on the number of occurrences counted for a routine of a given type (e.g., including an input text user action), and/or based on a set of constraints, criteria, and conditions concerning both routine types and counted number of instances for a given routine and/or a plurality of routines.

Embodiments of the invention may then group, split or classify found or gathered template instances (e.g., of corresponding routines and/or processes) according to an identifier or name of the target window or application into which the text or string was pasted (which may otherwise be referred to as a “second” app with reference to a “first” app from which the string was originally copied)—e.g., showing similar routines in which user pastes to Outlook and to Word as two different routines, even in cases identical texts or strings were pasted. At this stage, a new classification basis or dictionary may be created; dedicated functions may be used to receive template candidates and their underlying instances, to map a process name to a plurality of action IDs, and to return a data frame of text template associated actions including copying and pasting actions (e.g., such as the ones established using the procedure illustrated in FIG. 2) attached or associated with a single process name according to the target application or app (e.g., Candidate 1 Outlook; other naming and classification conventions may be used in different embodiments of the invention). This may be useful since it may be assumed that routines and processes used in the context of a particular target window or application should be considered and/or recognized as a distinct business routine or process, while routines and processes which differ by their target window may essentially involve different business functionalities (e.g., even in cases the underlying user actions may be similar or identical). Alternative assumptions, classifications, process identifiers, and naming conventions for template candidate routines and/or processes may be employed in other embodiments of the invention.

Given a set or inventory of template candidates classified based on process name or identifier, a plurality of template candidates (which may be strings or sets of strings) may be clustered and grouped to identify highly similar, yet slightly different templates as a single automation opportunity. Such procedure may be desirable in cases where different agents or users copy or insert slightly different versions of the same text or string for a given business task (e.g., in accordance with the example template provided herein: one agent may use “Many thanks” instead of “Thanks”, and yet keep all other fields unchanged); embodiments of the invention may therefore allow recognizing slightly different such template candidates as a single business routine or process which may, e.g., potentially be of high ROI. In some embodiments, such outcome may be achieved using an agglomerative hierarchical clustering algorithm or procedure. Alternative NLP procedures and clustering approaches may be used for clustering and/or unifying text template instances in other embodiments of the invention.

Embodiments of the invention may thus measure or calculate a distance, difference, or similarity score for pairs of strings, string sequences, or template candidates in order to check whether the two candidates should be considered as a single automation opportunity. In some embodiments, pairs of text template candidates may be merged or clustered iteratively, such that a distance is calculated for each member or the pair, and if the difference or distance between the distances is below a predetermined threshold—then the pair may be considered as single text template. In contrast, if the difference between individual scores for each member of the pair exceeds the threshold under consideration—then the two templates or clusters may be considered different—e.g., representing separate automation opportunities. Scores may be calculated for each template candidate, e.g., as part of word and/or string embedding and/or weighted/unweighted TF-IDF algorithms and using a variety of different distance metrics, e.g., Levenshtein distances as noted herein. Other algorithms, and/or schemes, and/or approaches in the context of calculating scores for individual candidates may be employed in different embodiments of the invention. In such manner, embodiments may allow iteratively calculating or measuring a similarity score for strings, string sequences, or groups and/or sets of strings, and iteratively clustering strings or sets of strings for which the similarity score or distance between similarity scores is below a predetermined threshold, to form final clusters which may be used or suggested as automation opportunities. An example distance metric which may be used on top of calculated scores or vector representations of strings (which may be achieved, for example, using word embedding techniques as known in the art) may, for example, employ a geometric or Euclidian distance formula such as:

$${‖ a - b ‖}_{2} = \sqrt{{\sum }_{i} {( {a}_{i} - {b}_{i} )}^{2}} \qquad ( 1 )$$

where a and b are a pair of vector embedding representations of text template candidates, and aᵢ and bᵢ represent the score calculated for a particular string sequence or instance i—or, in other words, a calculated value at index i for each vector—of candidate a and b, respectively. It may be seen that such formula may be used for clustering, e.g., it may group together candidates for which a short distance or small difference was calculated and account for different instances (e.g., including slightly different members of a given group of template candidates) in order to further check whether two groups or clusters of candidates should be further merged. A Jaccard similarity formula, e.g.:

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} \qquad ( 2 )$$

may constitute yet another example distance metric which may be used in some embodiments of the invention (which may be combined with an agglomerative-hierarchical clustering algorithm; such an embodiment is used as a non-limiting example herein). The Jaccard similarity formula may generally consider strings or sets of strings as mathematical sets which may or may not overlap. The similarity or difference between the sets may accordingly be calculated or measured. In formula 2 provided herein, |A∩B| denotes the intersection between sets A and B, while |A∪B| denotes the union between the two sets (which may be strings or sets of strings according to embodiments of the present invention). Alternative distance metrics, such as various sequence matching distances, may be used in other embodiments of the invention.

Grouping or clustering approaches such as hierarchical agglomerative clustering may therefore not require prespecifying the final number of clusters or text template automation opportunities to be provided as output. Such approaches, as well as alternative bottom-up NLP algorithms which may be used in other embodiments of the invention, may treat each candidate data as a singleton cluster at the outset in order to successively agglomerates pairs of clusters until all similar clusters (e.g., for which a distance shorter than the predetermined threshold was calculated) have been merged into a single cluster that contains all data. In some embodiments, an additional predetermined threshold may determine a stage where the clustering process should halt or stop—e.g., when candidates exceed a predetermined size or string length. This may be useful in cases where, e.g., erroneous large template candidates might be formed as result of noisy user action data (e.g., such that the clustering algorithm finds repeatedly high similarity or calculates short distances between clusters at different hierarchies or scales) which not represent desirable automation opportunities for actual business processes. Such threshold may therefore stop the clustering of templates at a string size corresponding to the business process which may, in fact, benefit from automation according to embodiments of the invention.

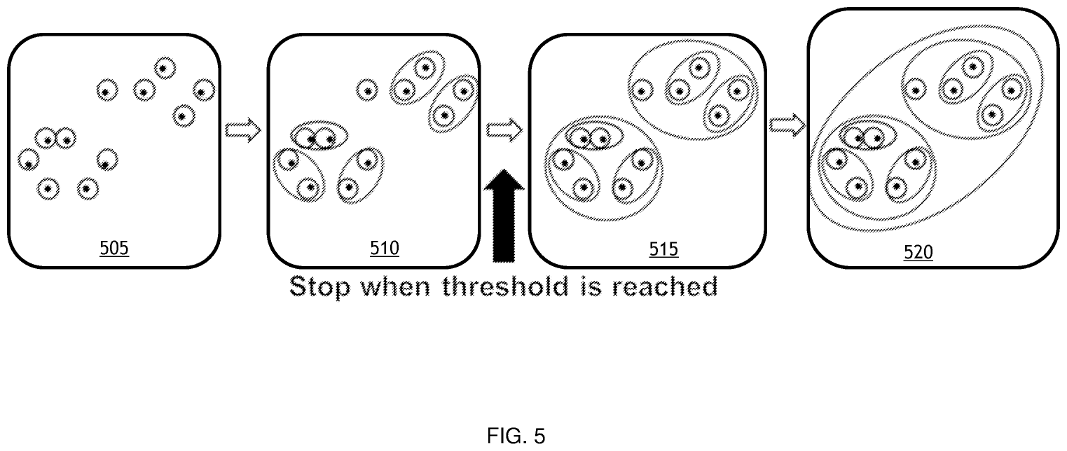

FIG. 5 is a simplified illustration of an agglomerative hierarchical clustering of text template candidates according to some embodiments of the invention. First, a set of text template instances may form initial clusters or “communities”, where points represent template instances and circles represent a cluster or group formed by the clustering algorithm—which may employ, e.g., a text or vector embedding technique to calculate scores for individual template instances, and/or a Jaccard similarity formula to calculate distances or differences between pairs of instances, for example as described herein (element 505). Next, the clustering procedure may group initial clusters together based on the calculated distance between the clusters; in such manner, initial clusters found within a short distance from one another (determined, e.g., using a predetermined threshold as described herein) may form intermediate clusters consisting for example of 1-2 initial clusters each (element 510). In yet another subsequent stage, intermediate clusters found within an appropriate distance may further be merged to form for example two final clusters, each consisting of three intermediate clusters (element 515). In the illustrated example, the resulting final clusters could, in principle, be further grouped into a single, large cluster consisting of all text template candidates under consideration (element 520). This, however, may be prevented in case such single large cluster does not represent a desirable automation opportunity (e.g., in case where it envelopes all text template candidates derived from user action data as explained herein, and where at least two actual automation opportunities should be distinguished from one another and may not be functionally equivalent) by using a predetermined threshold to stop the clustering procedure when template candidates and/or groups or clusters of such candidates reach an appropriate length and/or size, or after a certain number of clustering cycles or operations. In such manner, the illustrated clustering procedure may stop after only two clustering operations, resulting in two final clusters (e.g., as in element 510) instead of a single large cluster. Other constraints or stopping conditions for the clustering procedure may be incorporated or included in alternative embodiments of the invention.

Final clusters of text template candidates resulting from, e.g., an agglomerative hierarchical clustering procedure as described herein may be recommended, provided or presented to, e.g. a user or an automated process as routines and/or processes which may benefit from automation opportunities. In some embodiments of the invention, such opportunities may be recommended or presented to a user or business analyst using, for example, a GUI—where the user or business analyst may choose whether to accept or apply displayed opportunities and, e.g., incorporate them into the organization's activity as known in the art. In some embodiments, an automation score may be calculated for each automation opportunity in order to, e.g., assist a business analyst to assess or predict whether and/or to what extent the opportunity is expected to be desirable or beneficial for the organization. In other embodiments, opportunities for which automation scores are found to exceed a predetermined threshold may automatically be implemented or incorporated into the organization's computing systems without further intervention from a user or business analyst. Different frameworks and approaches for the calculation of automation scores and for automatically implementing automation opportunities in appropriate computer systems according to predefined criteria are known in the art. In this context, and using the AD approach as a non-limiting example, the list of actions of an output automation may be translated from, for example, the Automation Finder tool as a set of corresponding objects inside the Automation Studio tool by NICE, Ltd.; such objects, as well as workflow step(s) functions and screen elements may be managed by the latter NICE tool. Those skilled in the art, however, may recognize that alternative methods, and/or procedures, and/or approaches may be used for creating bots and executing automated processes in different embodiments of the invention.

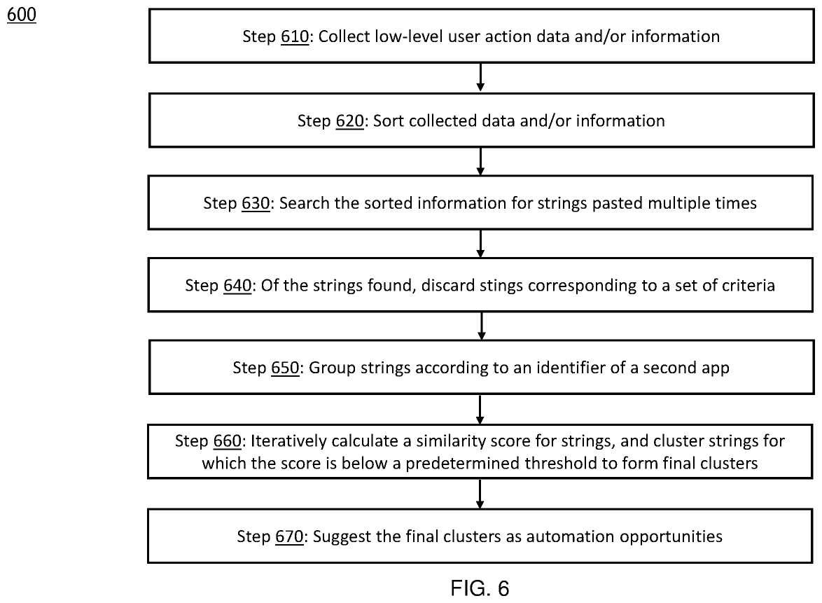

FIG. 6 is a flowchart depicting a simple text template discovery procedure according to some embodiments of the invention. In step 610, low-level user action data and/or information may be collected (for example using the NICE RT™ Client software, from a plurality of user terminals which may be for example personal computers connected to an organization's internal network and stored in a database, e.g., on a remote server—such as the NICE RT™ Server, in accordance with examples provided herein). Embodiments of the invention may then sort the collected low-level user action data and/or information, establishing a data-frame which may be used for discovering text template related actions and/or routines and/or processes as discussed herein (step 620). Embodiments may then search the sorted low-level action data and/or information for text or strings pasted multiple times, e.g., by a single agent or user (step 630). Of the strings found in the search—which may for example be stored in a bank or memory buffer containing text template candidates as explained herein—strings corresponding to a set of criteria (e.g., strings shorter than a predefined length) may subsequently be discarded or removed (step 640). Remaining strings may be grouped according to an identifier of the “second” app, e.g., the app to which a given string was pasted (as opposed to a “first” app from which the string was copied; step 650). A similarity score may then be calculated for grouped strings, and strings for which the score or distance (e.g., from the score calculated for a given string and a score calculated for another, different string) is below a predetermined threshold may be clustered together; this step may be performed iteratively e.g., individual strings stored in a text template candidate bank (such as disclosed herein) may be clustered or merged based on similarity scores (which may be calculated as explained herein) such that multiple candidates are unified to form a group of strings which may be regarded as a single candidate—then resulting groups of strings may be further clustered, merged, or grouped together with other strings or groups of strings (e.g., based on corresponding calculations on similarity scores) to form larger clusters of strings and/or groups of strings, and so forth. Such clustering procedure and corresponding calculations of similarity scores and distances may thus be repeated until final clusters are formed—e.g., according to a predetermined threshold that may set the size (e.g., maximum number of strings included) of such clusters (step 660). Finally, the resulting clusters may be suggested as automation opportunities. Suggesting may include, for example, displaying or providing on a display, e.g., to a business analyst using a dedicated GUI (step 670).

Embodiments of the invention may improve the technologies of computer automation, big data analysis, and computer use and automation analysis. Existing technologies and non-technology-based techniques to analyze computer use data to identify or determine automation opportunities suffer from numerous drawbacks, as explained elsewhere herein. For example, existing technologies are not capable of using low-level desktop events as input data. A human attempting to perform such an analysis would be faced with an unreasonably large amount of data. This is, as a practical matter, impossible to be performed by a human. Embodiments of the present invention may include a practical application of a series of algorithms which result in detection of computer processes which may be automated and the implementation and creation of computer automation processes. Some embodiments may be agnostic to the domain (e.g. the platform and specific programs as well as customer type, segment market, etc.) and language used for user interfaces, or other data, and may work with any data, for any specific programs the user interfaces with.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for string template discovery on a computer system, the method comprising using one or more computer processors:
sorting low-level user action information;
searching for a plurality of strings pasted multiple times in the sorted low-level user action descriptions;
of the strings found from the search, discarding one or more of the strings corresponding to a set of criteria;
grouping the strings according to an identifier of a second app; and
calculating a similarity score for strings, and clustering strings for which the similarity score is below a predetermined threshold, to form final clusters.

2. The method of claim 1, wherein a given string is included in one or more routines of different types, wherein each routine comprises a plurality of the low-level user actions.

3. The method of claim 1, comprising collecting, for a given string, one or more actions following or preceding a pasting of the string from the sorted low-level user action information; and
suggesting the final clusters as automation opportunities, wherein the opportunities comprise one or more of the actions.

4. The method of claim 3, wherein the actions comprise a list of sequences, each sequence including a list of one or more action identifiers, and wherein at least one of the identifiers describes one or more of: the string, the copying of the string, and a pasting of the string.

5. The method of claim 1, wherein the clustering comprises a hierarchical agglomerative clustering algorithm.

6. The method of claim 1, wherein the calculating of a similarity score further includes at least one of: calculating a distance between vector representations of string sequences, and calculating a similarity between sets of strings.

7. The method of claim 1, wherein the one or more of the strings corresponding to a set of criteria comprise at least one of: strings longer than a second predetermined threshold; strings not pasted from a first app to another, second app; strings not edited more than a predefined number of times within a time window by a user after pasting; and strings pasted fewer times than a third predetermined threshold.

8. The method of claim 1, comprising iteratively calculating one or more similarity scores for clusters of strings and grouping clusters for which the one or more of similarity scores is below a predetermined threshold.

9. A system for string template discovery, the system comprising:
a computer comprising a processor and a memory, wherein the processor is to:
sort low-level user action information;
search for a plurality of strings pasted multiple times in the sorted low-level user action descriptions;
of the strings found from the search, discard one or more of the strings corresponding to a set of criteria;
group the strings according to an identifier of a second app; and
calculate a similarity score for strings, and cluster strings for which the similarity score is below a predetermined threshold, to form final clusters.

10. The system of claim 9, wherein a given string is included in one or more routines of different types, wherein each routine comprises a plurality of the low-level user actions.

11. The system of claim 9, wherein the processor is to collect, for a given string, one or more actions following or preceding a pasting of the string from the sorted low-level user action information; and
suggest the final clusters as automation opportunities, wherein the opportunities comprise one or more of the actions.

12. The system of claim 11, wherein the actions comprise a list of sequences, each sequence including a list of one or more action identifiers, and wherein at least one of the identifiers describes one or more of: the string, the copying of the string, and a pasting of the string.

13. The system of claim 9, wherein the clustering comprises a hierarchical agglomerative clustering algorithm.

14. The system of claim 9, wherein the calculating of a similarity score further includes at least one of: calculating a distance between vector representations of string sequences, and calculating a similarity between sets of strings.

15. The system of claim 9, wherein the one or more of the strings corresponding to a set of criteria comprise at least one of: strings longer than a second predetermined threshold; strings not pasted from a first app to another, second app; strings not edited more than a predefined number of times within a time window by a user after pasting; and strings pasted fewer times than a third predetermined threshold.

16. The system of claim 9, wherein the processor is to iteratively calculate one or more similarity scores for clusters of strings and grouping clusters for which the one or more of similarity scores is below a predetermined threshold.

17. A method for string template discovery on a computer system, the method comprising using one or more computer processors:
organizing low-level user action information;
searching for one or more strings in the organized low-level user action information;
calculating a distance between similarity scores for strings, and clustering strings for which the distance is below a predetermined threshold, to form final clusters; and
providing the final clusters as automation opportunities.

18. The method of claim 17, comprising classifying the strings according to at least one of: a user executing the action, and an identifier of a second app;
collecting, for a given string, a window consisting of a set of actions associated with a pasting of the string from the sorted low-level user action information; and
including the one or more of the actions in the provided automation opportunities.

19. The method of claim 17, wherein the calculating of a distance comprises measuring at least one of: a geometric distance, and a difference between sets.

20. The method of claim 17, comprising, of the strings found from the search, removing at least one of: strings longer than a second predetermined threshold; strings not pasted from a first app to another, second app; and strings not edited more than a predefined number of times within a time window by a user after pasting; and strings pasted fewer times than a third predetermined threshold.
